(19) United States
(12) Patent Application Publication
(10) Pub. No.: US 2020/0232509 A1
(43) Pub. Date: Jul. 23, 2020

(54) Roller Bearing Assembly

(71) Applicant: General Electric Company, Schenectady, NY (US)

(72) Inventor: Tomasz Iglewski, Warsaw (PL)

(21) Appl. No.: 16/677,177

(22) Filed: Nov. 7, 2019

(30) Foreign Application Priority Data
Nov. 7, 2018 (PL) P.427671

(51) Int. Cl. F16C 33/60; F16C 19/16

(52) U.S. Cl. CPC F16C 33/60; F16C 2360/23; F16C 19/16

(57) ABSTRACT

An aspect of the present disclosure is directed to a housing and rotatable shaft apparatus. The apparatus includes a static structure, a rotor assembly, and a bearing assembly. The bearing assembly includes a first static race coupled to the static structure, a first rotatable race coupled to the rotor assembly, a first rolling bearing element disposed in contact between the first static structure and the first rotatable race, a support member coupled to the first static race, a second static race disposed within and coupled to the support member, and a second rotatable race disposed within the support member. The second rolling bearing element is disposed between the second static race and the second rotatable race.

### FIELD

The present subject matter relates generally to rolling bearing element assemblies.

### BACKGROUND

Rolling bearing element assemblies, such as ball bearings or roller bearings, may generally include a cage or other static structure separating the rolling bearing elements from one another. Such structures may generally contribute to energy losses at the bearing assembly. Such energy losses may result in thermal build-up, such as heat generation, that may generally require increased cooling fluid, such as lubricant. Such energy losses may further reduce structural life of the bearing assembly. Still further, the cage or other structure surrounding the rolling bearing elements may have a low tolerance for foreign matter, such as hard particles, between the cage and the rolling bearing elements.

As such, there is a need for a bearing assembly that may reduce energy losses, reduce thermal build-up, reduce a required cooling fluid or lubricant, improve structural life, or improve tolerance for foreign matter at the bearing assembly.

### BRIEF DESCRIPTION

Aspects and advantages of the invention will be set forth in part in the following description, or may be obvious from the description, or may be learned through practice of the invention.

An aspect of the present disclosure is directed to a bearing assembly. The bearing assembly includes a first static race, a first rotatable race, a first rolling bearing element disposed in contact between the first static race and the first rotatable race, a support member coupled to the first static race, a second static race disposed within the support member and coupled thereto, and a second rotatable race disposed within the support member. The second rolling bearing element is disposed between the second static race and the second rotatable race.

In one embodiment, the support member is extended axially from the first static race.

In various embodiments, the first static race includes a first inner race of the bearing assembly. In one embodiment, the first rotatable race includes a first outer race of the bearing assembly, and the first static race and the first rotatable race are each in loaded contact to the first rolling bearing element. In another embodiment, the second rotatable race includes a second inner race of the bearing assembly.

In still various embodiments, the first static race includes a first outer race of the bearing assembly, and the first rotatable race includes a first inner race of the bearing assembly. In one embodiment, the second rotatable race includes a second outer race of the bearing assembly, and the second static race includes a second inner race of the bearing assembly.

In one embodiment, the second rotatable race is disposed within the support member and freely rotatable therewithin.

In another embodiment, the bearing assembly includes a plurality of first rolling bearing elements in circumferential arrangement and a plurality of second rolling bearing elements in circumferential arrangement. The plurality of second rolling bearing elements is disposed within the support member, and each second rolling bearing element contacts a pair of the first rolling bearing element.

In another embodiment, the support member includes a first axially extended member extended from the first static race, a second axially extended member coupled to the second static race, and a radially extended member coupled to the first axially extended member and the second axially extended member.

Another aspect of the present disclosure is directed to a housing and rotatable shaft apparatus, such as a turbo machine. The apparatus includes a static structure, a rotor assembly, and a bearing assembly. The bearing assembly includes a first static race coupled to the static structure, a first rotatable race coupled to the rotor assembly, a first rolling bearing element disposed in contact between the first static structure and the first rotatable race, a support member coupled to the first static race, a second static race disposed within and coupled to the support member, and a second rotatable race disposed within the support member. The second rolling bearing element is disposed between the second static race and the second rotatable race.

In one embodiment of the apparatus, the support member includes a first axially extended member extended from the first static race, a second axially extended member coupled to the second static race, and a radially extended member coupled to the first axially extended member and the second axially extended member.

In another embodiment of the apparatus, the support member is extended axially from the first static race.

In various embodiments of the apparatus, the first static race defines an inner race of the bearing assembly. In one embodiment, the first rotatable race defines an outer race of the bearing assembly, and the first static race and the first rotatable race are each in loaded contact to the first rolling bearing element. In another embodiment, the second rotatable race defines an inner race of the bearing assembly.

In one embodiment, the second rotatable race, the second static race, and the first rolling bearing element are each in contact with the second rolling bearing element.

In another embodiment, the first static race defines an outer race of the bearing assembly, and the first rotatable race defines an inner race of the bearing assembly.

In yet another embodiment of the apparatus, the support member is extended axially from the first static race.

In still yet another embodiment of the apparatus, the second rotatable race is disposed within the support member and freely rotatable within the support member.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is an exemplary shaft and housing assembly according to an aspect of the present disclosure;

FIGS. 2-3 are perspective views of exemplary embodiments of a bearing assembly according to an aspect of the present disclosure;

FIG. 4 is a cutaway perspective view of an exemplary embodiment of the bearing assembly; and

FIGS. 5-6 are close up cutaway perspective views of exemplary embodiments of the bearing assembly.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Embodiments of a bearing assembly that may reduce energy losses, reduce cooling and/or lubricant fluid requirements, improve structural life, improve tolerance to foreign matter, and reduce thermal generation are generally provided. The bearing assembly generally provided herein may provide one or more of such benefits via a main or primary load-bearing rolling bearing element supported via a supporting or secondary rolling bearing element. The supporting rolling bearing element is generally and substantially not transferring loads through the bearing assembly. The supporting rolling bearing element spins along its own axis in a direction opposite relative to the direction of spin of the load-bearing rolling bearing element. As such, sliding between each of the load-bearing rolling bearing element and the support bearing element is eliminated. Still further, the load-bearing and supporting rolling bearing elements are generally in rolling contact rather than sliding arrangement relative to one another.

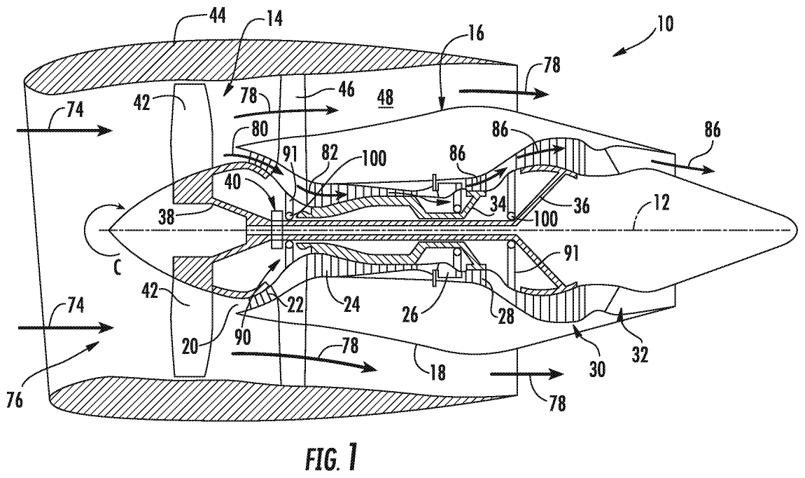

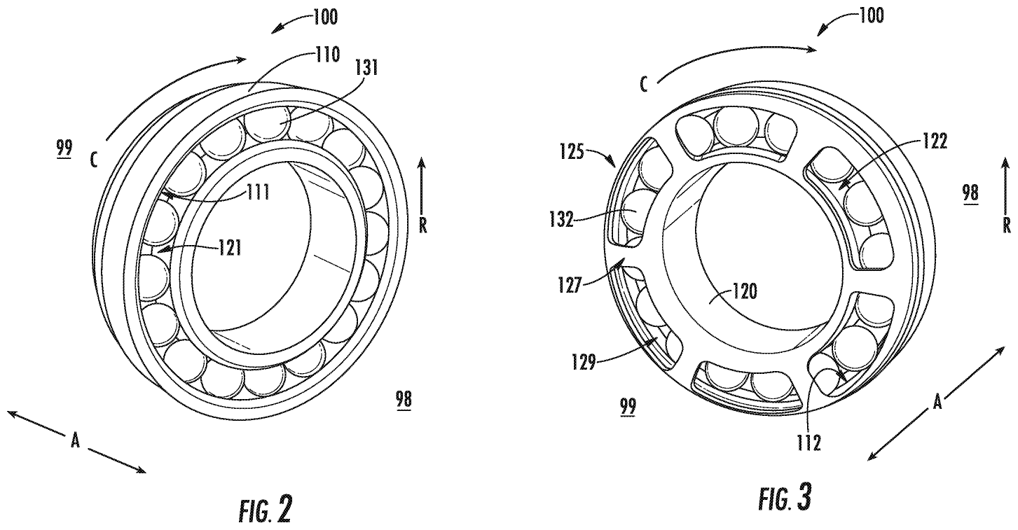

Referring now to the drawings, FIG. 1 is a schematic of an exemplary embodiment of a shaft and housing assembly (hereinafter, “apparatus 10”), including embodiments of a bearing assembly 100 according to the present disclosure. The apparatus 10 generally includes a static structure 91 generally supporting rotation of a rotor assembly 90. Between the static structure 91 and the rotor assembly 90 is the bearing assembly 100 further shown and described in regard to FIGS. 2-6.

The exemplary embodiment of the apparatus 10 provided in regard to FIG. 1 may define a turbo machine as may incorporate various embodiments of the bearing assembly 100 according to the present disclosure. Although further described below with reference to a gas turbine engine, the present disclosure is generally applicable to bearing assemblies, and shaft and housing assemblies generally. Embodiments of the apparatus 10 described herein may include turbomachinery in general, including turbofan, turbojet, turboprop, and turboshaft gas turbine engines, marine and industrial turbine engines and auxiliary power units, steam turbine engines, or other rotary machines that include bearing assemblies.

As shown in FIG. 1, the exemplary embodiment of the apparatus 10 defining a turbo machine has a longitudinal or axial centerline axis 12 that extends there through for reference purposes. In general, the apparatus 10 may include a fan assembly 14 and a core engine 16 disposed downstream from the fan assembly 14.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 by way of a reduction gear 40 such as in an indirect-drive or geared-drive configuration. In other embodiments, the apparatus 10 may further include an intermediate pressure compressor and turbine rotatable with an intermediate pressure shaft altogether defining a three-spool gas turbine engine.

As shown in FIG. 1, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. In one embodiment, the nacelle 44 may be supported relative to the core engine 16 by a plurality of circumferentially-spaced outlet guide vanes or struts 46. Moreover, at least a portion of the nacelle 44 may extend over an outer portion of the core engine 16 so as to define a bypass airflow passage 48 therebetween.

During operation of the apparatus 10 defining a turbo machine, a volume of air as indicated schematically by arrows 74 enters the apparatus 10 through an associated inlet 76 of the nacelle 44 and/or fan assembly 14. As the air 74 passes across the fan blades 42 a portion of the air as indicated schematically by arrows 78 is directed or routed into the bypass airflow passage 48 while another portion of the air as indicated schematically by arrow 80 is directed or routed into the LP compressor 22. Air 80 is progressively compressed as it flows through the LP and HP compressors 22, 24 towards the combustion section 26, such as depicted schematically by arrows 82. The compressed air 82 flows into the combustion section 26.

The compressed air 82 is mixed with a liquid and/or gaseous fuel and burned, thus generating combustion gases, as indicated schematically by arrows 86, within the combustion section 26. The combustion gases 86 flow downstream and expand at the HP turbine 28 and the LP turbine 30 to drive the respective HP compressor 24 and LP compressor 22 attached thereto.

Referring still to FIG. 1, the combinations of the HP compressor 24, the HP shaft 34, and the HP turbine 28, or the LP compressor 22, the LP shaft 36, and the LP turbine 30, may define a rotor assembly 90 of the apparatus 10. In other embodiments, such as described above, the apparatus 10 defining a turbo machine including the rotor assembly 90 may include combinations of the intermediate compressor, intermediate shaft, and intermediate turbine. Various embodiments of the apparatus 10 defining a turbo machine may include the static structure 91 defining the outer casing 18 or another casing or mount structure supporting the rotor assembly 90.

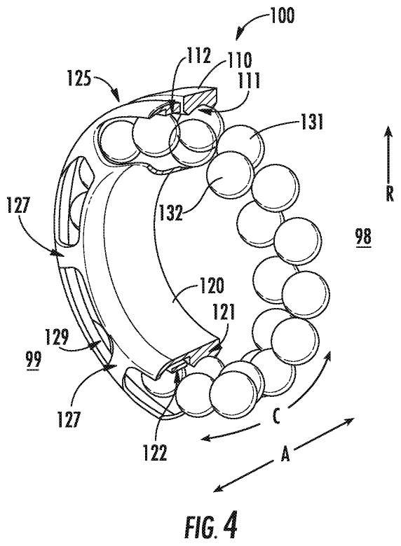

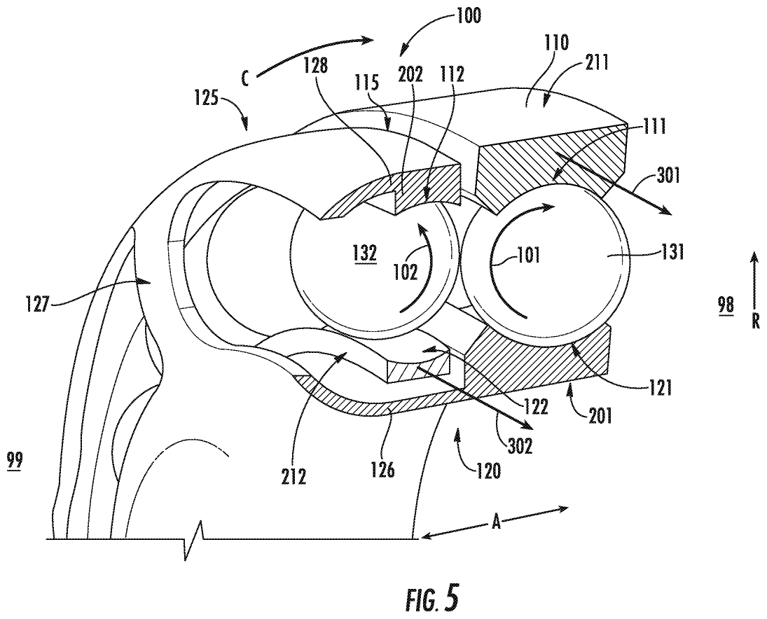

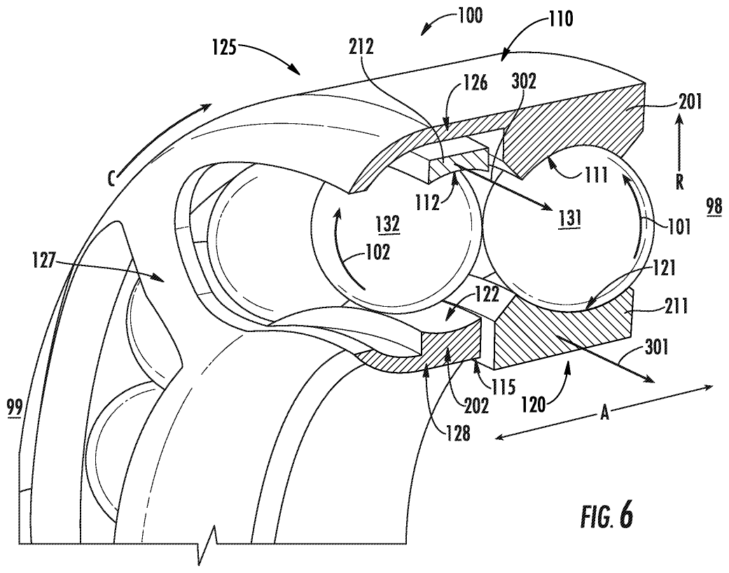

Referring now to FIGS. 2-3, perspective views of exemplary embodiments of the bearing assembly 100 are generally provided. Referring additionally to FIGS. 4-6, cutaway perspective views of exemplary embodiments of the bearing assembly 100 are further provided. Referring to FIGS. 2-6, a first end 99 and a second end 98 opposite thereof along an axial direction A are each defined for reference purposes. The bearing assembly 100 includes a first rotatable race 211 and a first static race 201 each coupled to or otherwise directly touching a first rolling bearing element 131 therebetween (see FIGS. 5 & 6). A second rotatable race 212 and a second static race 202 are each coupled to or otherwise directly touching a second rolling bearing element 132 therebetween.

The bearing assembly 100 generally includes a plurality of the first rolling bearing element 131 in circumferential arrangement (i.e., in adjacent arrangement along a circumferential direction C). The bearing assembly 100 further includes a plurality of the second rolling bearing element 132 in circumferential arrangement. The plurality of the second rolling bearing element 132 may generally define a supporting element such as to separate each pair of circumferentially-spaced first rolling bearing elements 131 (see FIGS. 4-6). The plurality of the first rolling bearing element 131 may generally define a main or substantially loaded or load-bearing rolling bearing element (e.g., load bearing in regard to loads between the rotor assembly 90 and the static structure 91). As such, each second rolling bearing element 132 is disposed within a support member 125 (described further below), and is in contact with a pair of circumferentially adjacent first rolling bearing elements 131 such as to circumferentially space-apart each pair of first rolling bearing elements 131 (see FIGS. 3-6).

Referring to FIGS. 2-5, the bearing assembly 100 generally defines a cross pattern of the static races 201, 202 and rotatable races 211, 212. For example, referring to FIG. 5, in one embodiment, the cross pattern is defined by the first rotatable race 211 including a first outer race 111 coupled radially outward (along a radial direction R) to the first rolling bearing element 131 diagonally across the second rotatable race 212 including a second inner race 122 coupled radially inward to the second rolling bearing element 132. Similarly, the first static race 201 includes a first inner race 121 coupled radially inward to the first rolling bearing element 131 diagonally across the second static race 202 including a second outer race 112 coupled radially outward to the second rolling bearing element 132.

In another exemplary embodiment, such as depicted in regard to FIG. 6, the cross pattern is defined by the first static race 201 including the first outer race 111 coupled radially outward to the first rolling bearing element 131 diagonally across the second static race 202 including the second inner race 122 coupled radially inward to the second rolling bearing element 132. Similarly, the first rotatable race 211 includes the first inner race 121 coupled radially inward to the first rolling bearing element 131 diagonally across the second rotatable race 212 including the second outer race 112 coupled radially outward to the second rolling bearing element 132.

The bearing assembly 100 generally provided in regard to FIGS. 2-6 may generally obviate the need for a cage separating rolling bearing elements of a bearing assembly. During operation of the bearing assembly 100, or the apparatus 10 to which the bearing assembly 100 is attached, the first rolling bearing element 131 and the second rolling bearing element 132 may each generally rotate in place along its own respective axis, such as depicted via arrows 101, 102 (see FIGS. 5 & 6). For example, the first rolling bearing element 131 may be constrained from sliding along the circumferential direction C via the first outer race 111, the first inner race 121, and the second rolling bearing element 132. As another example, the second rolling bearing element 132 may be constrained from sliding along the circumferential direction C via the second outer race 112, the second inner race 122, and the first rolling bearing element 131. As such, the first rolling bearing element 131 may rotate along the first direction 101 along its own axis and the second rolling bearing element 132 may rotate along the second direction 102 opposite of the first direction 101 along its own respective axis. Stated differently, the first rolling bearing element 131 and the second rolling bearing element 132 may be disposed in counter-rotational arrangement relative to one another.

During operation of one exemplary embodiment of the bearing assembly 100, such as depicted in regard to FIG. 5, the first outer race 111 defining the first rotatable race 211 is configured to rotate in the circumferential direction C, such as depicted schematically via arrow 301. For example, the first outer race 111 is attached to the rotor assembly 90 (FIG. 1). The first inner race 121 defining the first static race 201 is attached to the static structure 91 (FIG. 1).

During operation of another exemplary embodiment of the bearing assembly 100, such as depicted in regard to FIG. 6, the first inner race 121 defining the first rotatable race 211 is configured to rotate in the circumferential direction C, such as depicted schematically via arrow 301. For example, the first inner race 121 is attached to the rotor assembly 90 (FIG. 1). The first outer race 111 defining the first static race 201 is attached to the static structure 91 (FIG. 1).

Referring to FIGS. 3-6, the support member 125 is extended axially and radially to couple the first static race 201 together with the second static race 202 (e.g., each of the static races 201, 202 coupled to the static structure 91 in FIG. 1 via the support member 125). The support member 125 is extended axially and radially to enable the cross pattern arrangement of the first static race 201 and the second static race 202. For example, referring to FIG. 5, the support member 125 enables the first static race 201 to couple to a radially inward portion of the first rolling bearing element 131, and further enables the second static race 202 to couple diagonally opposite of the first static race 201 at a radially outward portion of the second rolling bearing element 132. As another example, referring to FIG. 6, the support member 125 enables the first static race 201 to couple to a radially outward portion of the first rolling bearing element 131, and further enables the second static race 202 to couple diagonally opposite of the first static race 201 at a radially inward portion of the second rolling bearing element 132.

It should be appreciated that although FIGS. 2-6 depict a single support member 125 extended from the first static race 201, in various embodiments the support member 125 may be extended in either or both directions (e.g., along the axial direction A) from the first static race 201, such as to include two or more circumferential rows of second rolling bearing element 132 in contact with the first rolling bearing element 131 (e.g., the second rolling bearing element 132 of each circumferential row in contact with opposite ends of the first rolling bearing element 131 along the axial direction A).

Referring to FIGS. 3-6, in various embodiments, the support member 125 includes a first axially extended member 126 and a second axially extended member 128. A radially extended member 127 is coupled to both of the first axially extended member 126 and the second axially extended member 128. The first axially extended member 126 and the second axially extended member 128 may each extend substantially circumferentially, such as to retain the second rolling bearing element 132 radially therebetween. In various embodiments the support member 125 including the axially extended members 126, 128 coupled together via the radially extended member 127 may define a spring structure of the support member 125, such as to enable reduced tension that may mitigate sliding of the rolling bearing elements 131, 132.

The first axially extended member 126 is generally extended along the axial direction A from the first static race 201. The second axially extended member 128 may be disposed radially opposite of the first axially extended member 126 such as to retain the second rolling bearing element 132 therebetween. The radially extended member 127 supports and couples the radially opposite arrangement of the first axially extended member 126 and the second axially extended member 128.

In various embodiments, the support member 125 defines one or more surfaces at which the second rotatable race 212 may freely rotate or slide within the support member 125 between the axially extended members 126, 128, such as to enable rotation of each of the second rolling bearing element 132 along its own respective axis. Referring to FIGS. 5-6, the first axially extended member 126 may, at least in part, define a surface at which the second rotatable race 212 may freely rotate or slide along the circumferential direction C. As such, the first axially extended member 126 of the support member 125 may define a surface at which the second rotatable race 212 is disposed between the support member 125 and the second rolling bearing element 132.

For example, referring to FIG. 5, the second inner race 122 defining the second rotatable race 212 is disposed radially inward of the second rolling bearing element 132 between the second rolling bearing element 132 and the first axially extended member 126 of the support member 125. As another example, referring to FIG. 6, the second outer race 112 defining the second rotatable race 212 is disposed radially outward of the second rolling bearing element 132 between the second rolling bearing element 132 first axially extended member 126 of the support member 125.

Referring to FIGS. 5-6, the second axially extended member 128 may, at least in part, define a surface at which the second static race 202 is defined between the second axially extended member 128 and the second rolling bearing element 132. For example, referring to FIG. 5, the second inner race 122 defining the second static race 202 is disposed radially outward of the second rolling bearing element 132 between the second rolling bearing element 132 and the second axially extended member 128 of the support member 125. As another example, referring to FIG. 6, the second outer race 112 defining the second static race 202 is disposed radially inward of the second rolling bearing element 132 between the second rolling bearing element 132 and the second axially extended member 128 of the support member 125.

The support member 125 generally provides a cross connection attachment via the radially extended member 127 such as to provide the second static race 202 diagonally opposite of the first static race 201 and the second rotatable race 212 diagonally opposite of the first rotatable race 211, such as described in regard to FIGS. 5-6. Various embodiments of the bearing assembly 100 may include a plurality of the radially extended member 127 coupling together the first axially extended member 126 and the second axially extended member 128 of the support member 125, such as depicted in regard to FIGS. 3-6. Each radially extended member 127 may be spaced apart along the circumferential direction C such as to provide a desired structural support, stiffness, or flexibility of the support member 125. As such, the radially extended member 127, or a plurality thereof (e.g., two or more), may define an opening 129 (FIGS. 3-4) between the radially extended member(s) 127, the first axially extended member 126, and the second axially extended member 128. The gap 129 may beneficially reduce weight and/or energy losses at the support member 125 and overall bearing assembly 100.

The second static race 202 defined at and attached to the support member 125 is configured in static or stationary arrangement. The second rotatable race 212 is disposed in free rotating or unconstrained arrangement between the support member 125 and the second rolling bearing element 132. As such, the bearing assembly 100 defines a rotatable arrangement enabling free rotation of the second rotatable race 212 along the circumferential direction C, such as depicted schematically via arrow 302 co-directional to directional arrow 301 (see FIGS. 5 & 6). Rotation of the second rotatable race 212 during operation of the bearing assembly 100 enables rotation of the second bearing element 132 along its own axis (e.g., along the second direction 102) rather than sliding of one or more of the bearing elements 131, 132 along the circumferential direction C.

Although the first rolling bearing element 131 and the second rolling bearing element 132 are generally depicted as substantially similarly sized, it should be appreciated that in various embodiments the first rolling bearing element 131 and the second rolling bearing element 132 may define different sizes. In one embodiment, the second rolling bearing element 132 may be defined smaller than the first rolling bearing element 131. The differing sizes of the first rolling bearing element 131 and the second rolling bearing element 132 may enable different magnitudes of rotational speed of the second rotatable race 212 relative to the first rotatable race 211. For example, in embodiments where the second rolling bearing element 132 is smaller than the first rolling bearing element 131, the second rotatable race 212 may freely rotate at a larger magnitude rotational speed relative to the first rotatable race 211.

The differing sizes of the first rolling bearing element 131 and the second rolling bearing element 132 relative to each other may reduce mass and inertia of the bearing assembly 100. Although the first rolling bearing element 131 and the second rolling bearing element 132 may define similar or the same material, in various embodiments the first rolling bearing element 131 and the second rolling bearing element 132 may define different materials from one another. In one embodiment, the first rolling bearing element 131 may define one or more first materials suitable for load transfer between the static structure 91 and the rotor assembly 90 (FIG. 1), such as a metal (e.g., steel, chrome steel, etc.). In various embodiments, the second rolling bearing element 132 may define a second material different from the first material, such as non-metallic materials (e.g., polymers), composites, lighter-mass metallic materials, or another material defining a reduced mass, reduced strength, or reduced load-bearing capability relative to the first material of the first rolling bearing element 131. In still another embodiment, the second material of the second rolling bearing element 132 may define properties more suitable for vibration damping of the bearing assembly 100 relative to the first material of the first rolling bearing element 131. As such, the differing materials between the first rolling bearing element 131 and the second rolling bearing element 132 may enable reduced mass, inertia, vibrations, etc. at the bearing assembly 100, such as to improve efficiency and operability, or reduce energy losses, such as thermal build-up and accumulation, or undesired vibratory responses.

Referring now to FIGS. 2-6, in various embodiments, the bearing assembly 100 includes a first outer race structure 110 at which the first outer race 111 is defined. The bearing assembly 100 further includes a first inner race structure 120 at which the first inner race 121 is defined. The first rolling bearing element 131 is disposed between the first outer race 111 and the first inner race 121. For example, the first rolling bearing element 131 is disposed, coupled, or otherwise directly touching the first outer race 111 and the first inner race 121 in a loaded arrangement therebetween.

Referring to FIGS. 5-6, the bearing assembly 100 generally defines a separation or gap 115 between the first rotatable race 211 and the second static race 202. The gap 115 is defined between the first rotatable race 211 and the support member 125 including the second static race 202. The gap 115 generally defines a de-coupling at the bearing assembly 100 of the first rotatable race 211 (e.g., coupled to the rotor assembly 90 in FIG. 1) and the support member 125 (e.g., coupled to the static assembly 91 in FIG. 1), including the first static race 201 and the second static race 202. Additionally, the second rotatable race 212 defined within the support member 125 is de-coupled from the rotor assembly 90 such as to enable free rotation of the second rotatable race 212 within the support member 125.

Various embodiments of the bearing assembly 100 shown and described herein provide separation of a main or primary load-bearing rolling bearing element (e.g., first rolling bearing element 131) via a supporting or secondary rolling bearing element (e.g., second rolling bearing element 132). The supporting rolling bearing element is generally and substantially not transferring loads through the bearing assembly 100 (e.g., 90% or greater of loads between the rotor assembly 90 and the static assembly 91 are transferred through the first rolling bearing element 131 without transferring to the second rolling bearing element 132). The (or each) second rolling bearing element 132 spins along its own respective axis in an opposite direction (e.g., second direction 102) relative to the direction of spin of the first rolling bearing element 131 (e.g., first direction 101). As such, sliding along the circumferential direction C between each of the first and second rolling bearing elements 131, 132 is substantially or completely eliminated. The first static race 201 and the second static race 202 are each coupled to the support member 125. The second rotatable race 212 within the support member 125 is freely rotatable along the circumferential direction C between the second rolling bearing elements 132 and the support member 125 (e.g., adjacent the first axially extended member 126). As such, the rolling bearing elements 131, 132 are in rolling contact rather than sliding arrangement along circumferential direction C.

Embodiments of the bearing assembly 100 generally provided herein may obviate a cage or other static structure between each circumferentially adjacent pair of first rolling bearing elements 131. Embodiments of the bearing assembly 100 may reduce energy losses, reduce thermal generation (e.g., heat buildup), reduce cooling requirements (e.g., reduced cooling fluid or lubricant), reduce lubricant requirements (e.g., reduced lubricant), generally improve structural life of the bearing assembly 100, and/or generally improve tolerance to foreign matter or particles between the rolling bearing elements 131, 132, in contrast to known bearing assemblies (e.g., via the opening 129 defined by the radially extended members 127 of the support member 125).

Various embodiments of the bearing assembly 100 may be manufactured by one or more processes generally known in the art, such as, but not limited to, additive manufacturing or 3D printing, casting, forging, milling, drilling, or other machining processes, or bonding processes, or combinations thereof. The bearing assembly 100 may further include one or more materials generally known in the art suitable for rolling bearing element assemblies, including metallic, non-metallic, or composite materials. Various embodiments of the bearing assembly 100 may be configured as a thrust bearing, such as including a ball bearing or tapered roller bearing, or generally as a roller bearing assembly, or combinations thereof. As such, although the first and second rolling bearing elements 131, 132 are generally depicted as ball bearings, other embodiments not depicted herein may include cylindrical bearings, or other rolling bearing element configurations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A bearing assembly, the bearing assembly comprising:
a first static race;
a first rotatable race;
a first rolling bearing element disposed in contact between the first static race and the first rotatable race;
a support member coupled to the first static race;
a second static race disposed within the support member and coupled thereto; and
a second rotatable race disposed within the support member, wherein the second rolling bearing element is disposed between the second static race and the second rotatable race.

2. The bearing assembly of claim 1, wherein the support member is extended axially from the first static race.

3. The bearing assembly of claim 1, wherein the first static race comprises a first inner race of the bearing assembly.

4. The bearing assembly of claim 3, wherein the first rotatable race comprises a first outer race of the bearing assembly, and wherein the first static race and the first rotatable race are each in loaded contact to the first rolling bearing element.

5. The bearing assembly of claim 4, wherein the second rotatable race comprises a second inner race of the bearing assembly.

6. The bearing assembly of claim 1, wherein the first static race comprises a first outer race of the bearing assembly, and wherein the first rotatable race comprises a first inner race of the bearing assembly.

7. The bearing assembly of claim 6, wherein the second rotatable race comprises a second outer race of the bearing assembly, and wherein the second static race comprises a second inner race of the bearing assembly.

8. The bearing assembly of claim 1, wherein the second rotatable race is disposed within the support member and freely rotatable therewithin.

9. The bearing assembly of claim 1, further comprising a plurality of first rolling bearing elements in circumferential arrangement and a plurality of second rolling bearing elements in circumferential arrangement, wherein the plurality of second rolling bearing elements is disposed within the support member, and wherein each second rolling bearing element contacts a pair of the first rolling bearing element.

10. The bearing assembly of claim 1, wherein the support member comprises:
a first axially extended member extended from the first static race;
a second axially extended member coupled to the second static race; and
a radially extended member coupled to the first axially extended member and the second axially extended member.

11. A housing and rotatable shaft apparatus, the apparatus comprising:
a static structure;
a rotor assembly;
a bearing assembly comprising:
a first static race coupled to the static structure;
a first rotatable race coupled to the rotor assembly;
a first rolling bearing element disposed in contact between the first static race and the first rotatable race;
a support member coupled to the first static race;
a second static race disposed within the support member and coupled thereto; and
a second rotatable race disposed within the support member, wherein the second rolling bearing element is disposed between the second static race and the second rotatable race.

12. The apparatus of claim 11, wherein the support member comprises:
a first axially extended member extended from the first static race;
a second axially extended member coupled to the second static race; and
a radially extended member coupled to the first axially extended member and the second axially extended member.

13. The apparatus of claim 11, wherein the support member is extended axially from the first static race.

14. The apparatus of claim 11, wherein the first static race defines an inner race of the bearing assembly.

15. The apparatus of claim 14, wherein the first rotatable race defines an outer race of the bearing assembly, and wherein the first static race and the first rotatable race are each in loaded contact to the first rolling bearing element.

16. The apparatus of claim 14, wherein the second rotatable race defines an inner race of the bearing assembly.

17. The apparatus of claim 11, wherein the second rotatable race, the second static race, and the first rolling bearing element are each in contact with the second rolling bearing element.

18. The apparatus of claim 11, wherein the first static race defines an outer race of the bearing assembly, and wherein the first rotatable race defines an inner race of the bearing assembly.

19. The apparatus of claim 11, further comprising a plurality of first rolling bearing elements in circumferential arrangement and a plurality of second rolling bearing elements in circumferential arrangement, wherein the plurality of second rolling bearing elements is disposed within the support member, and wherein each second rolling bearing element contacts a pair of the first rolling bearing element.

20. The apparatus of claim 11, wherein the second rotatable race is disposed within the support member and freely rotatable therewithin.
